(19) United States
(12) Patent Application Publication
(10) Pub. No.: US 2020/0365307 A1
(43) Pub. Date: Nov. 19, 2020

(54) DC/Universal Electric Motor

(71) Applicant: John William McConnell, Cedar Rapids, IA (US)

(72) Inventor: John William McConnell, Cedar Rapids, IA (US)

(21) Appl. No.: 16/246,500

(22) Filed: May 17, 2019

(51) Int. Cl. H01F 7/14; F02D 11/10

(52) U.S. Cl. CPC H01F 7/145; H02K 3/28; F02D 2011/102; F02D 11/10

(57) ABSTRACT

An Electric Motor consisting of a rotor fitted with either a permanent unipolar radial magnet or a unipolar radial electromagnet encircled by two or more air-core stator electromagnets in series circuit. The stator coils are wound such that they send electric current in the same direction down lengths of wire parallel to the rotor's axis of rotation. When voltage is applied to the windings, the current causes forces to act on the rotor next to where the stator coils sit, and no back-voltage is generated in the stator coils or the radial unipolar electromagnet due to the fact that there is no change in the magnetic flux density passing through them. This causes the production of smooth, continuous torque regardless of the motor's turning speed.

### CROSS-REFERENCE TO RELATED APPLICATIONS

(Not Applicable)

### STATEMENT REGARDING FEDERALLY SPONSORED RESEARCH OR DEVELOPMENT

(Not applicable)

### REFERENCE TO A SEQUENCE LISTING, A TABLE, OR A COMPUTER PROGRAM COMPACT DISC APPENDIX

(Not applicable)

### BACKGROUND OF THE INVENTION

The invention pertains to any and all applications in which rotary mechanical power is obtained from DC or AC electrical power.

### BRIEF SUMMARY OF THE INVENTION

The invention is a new and useful device which acts as a means to convert electrical power to rotary mechanical power without a voltage drop proportional to turning speed or, in the case of DC electricity, power losses due to dry friction in a commutator or complex electronic controls. It is a rotating shaft on which is fitted either a toroidal unipolar radial permanent magnet (a magnet shaped like a torus, or doughnut, whose poles are on the exterior and interior of the ring to produce a radiating magnetic field) or an electromagnet consisting of two opposite twist conductive windings around the shaft in series circuit which produce a radiating unipolar magnetic field when energized, sitting inside a group of two or more conductive coils, which are wired in series, mounted with nonmagnetic materials and arranged with radial symmetry around the magnet cylinder such that when electrically excited, the electric current in the lengths of each coil passing closest to the rotor magnet flows both in the same direction and parallel to the rotor's axis of rotation. When electricity is passed through these electromagnets, a series of forces act on the magnet on the shaft around its perimeter, forming a loop of forces around the magnet radius. These forces cancel one another out such that they don't place a transverse load on the shaft and produce smooth, consistent torque.

### BRIEF DESCRIPTION OF THE DRAWINGS

Three drawings are included with the specification for the patent for this particular invention. The first is an isometric 3D view of the completed general concept of the invention, showing the minimum number of elements necessary for proper function. The second is an exploded view at the same angle, showing other necessary components and giving a detailed view of the basic assembly of the device. The third consists of three figures; Figures (a) and (b) are 2D cross sections of both kinds of magnet cylinder (see Detailed Description below) showing the proper configuration of stator coils around each one, as well as the basic circuitry for each setup, and Figure (c) is a legend for proper comprehension of Figures (a) and (b).

### DETAILED DESCRIPTION OF THE INVENTION

The invention itself (hereafter referred to as ‘the motor’) consists of the following parts: a central fulcrum attached to a housing (hereafter referred to as ‘the frame’), a shaft running through the fulcrum onto which is mounted a cylinder consisting of either a unipolar radial permanent magnet or a unipolar radial electromagnet (an electromagnet consisting of two opposite twist conductive windings, that is, one winding wound clockwise and another wound counterclockwise, wound around a magnetically conductive cylinder in grooves cut in the side at either end and wired in series to produce a radiating, unipolar magnetic field) energized by contacts on the ends of the cylinder leading to the ends of the windings (hereafter referred to as ‘the magnet cylinder’), two or more coils of conductive wire mounted to the frame (hereafter referred to as ‘stator coils’) and ball bearings to allow fitting and lubrication between the magnet cylinder's rotor and the frame, although liquid lubrication in the form of motor oil or grease may be used instead.

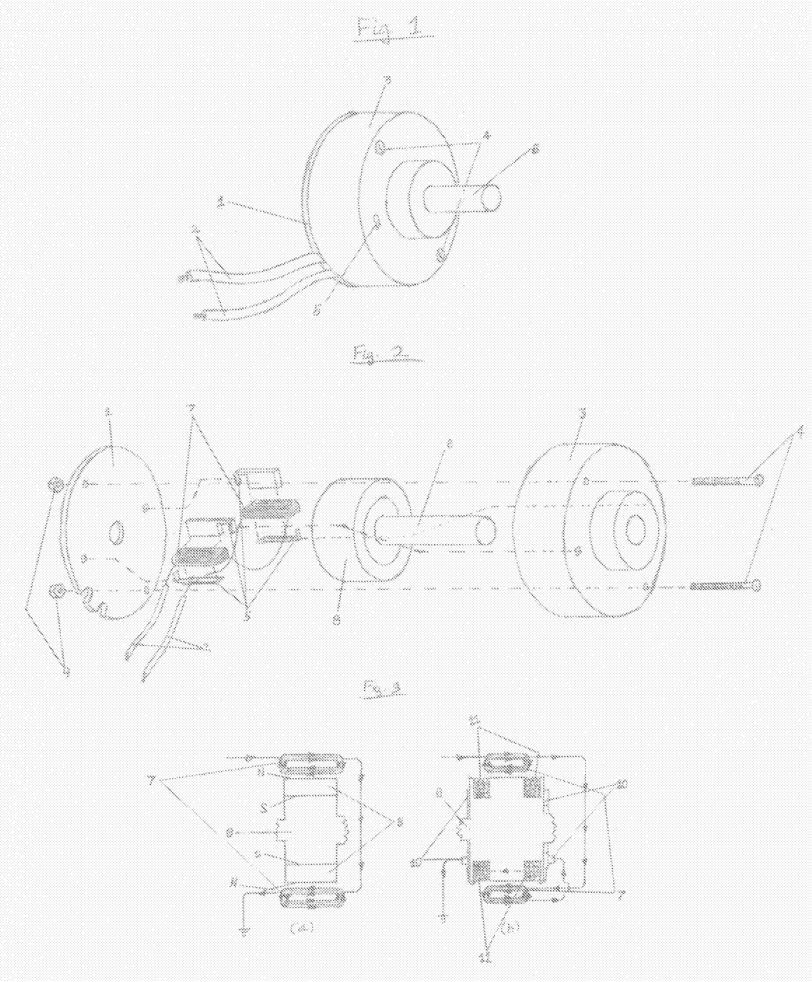

The mechanics of the motor are as follows: the stator coils are arranged with radial symmetry around the magnet cylinder and wired in series with each other successively, and are wound such that each coil will have a length running parallel to the axis of rotation of the magnet cylinder and such that the electric current in each parallel length moves in the same direction (see FIG. 3 for details). (‘Radial Symmetry’ refers to having copies of one object arranged in a circle and spaced equally far apart so as to form a pattern similar to a starburst.) The magnet cylinder sits in the center of this arrangement and is sized so that the magnet on its outside edge is as close to the stator coils as it can be without contacting the stator coils themselves.

When DC electricity is fed to the stator coils, the electric current in each stator coil interacts with the magnetic field emanating from the magnet cylinder to produce a force on the stator coil called Lorentz Force, which acts on each stator coil in a direction which is perpendicular both to the length of the wires affected and to the magnetic field from the magnet cylinder. The force acts in the opposite direction on the magnet cylinder at the positions of each stator coil, producing a loop of forces around the magnet cylinder. Due to the radial symmetry of the stator coils, these forces produce torque on the magnet cylinder and cancel each other out, leaving no transverse load on the shaft or the frame. When the torque from each stator coil is added together, the torque produced is constant and equal in magnitude to the following formula:

T=nₛₘn_{wind}i l_{wire}B r_{mc}

where nₛₘ is the number of stator coils, n_{wind} is the number of coil winds per stator coil, l_{wire} is the length of the loop of wire in the stator coil which is parallel to the magnet cylinder's axis of rotation, “i” is the electric current flowing through the stator coils, B is the magnetic flux density of the magnet cylinder (proportional to magnetic field strength), and r_{mc} is half the diameter of the magnet cylinder at it at its widest, that is, where the magnets themselves are present.

In the case of the universal motor setup, where the magnet cylinder is a unipolar radial electromagnet, the magnet cylinder windings can either be in series circuit or in parallel circuit with the stator coils. The series circuit setup leads to lower power usage and lower torque output; the parallel setup leads to higher power usage and higher output torque.

It should be noted that the stator coils should have air-cores (they should not have ferromagnetic, or magnetically conductive, cores) and should be mounted using nonmagnetic materials, such as plastics or nonmagnetic metals such as copper or aluminum. This is for the following reasons: 1) with a ferromagnetic core, the torque generated will be considerably decreased due to the fact that equal and opposite Lorentz forces will be acting on the magnet cylinder due to the radial magnetic field interacting with current flowing in opposite directions, and 2) during operation, the magnet cylinder's magnetic field will interact with a ferromagnetic core such that it will generate a voltage drop in the stator coils and/or the magnet cylinder windings proportional to the motor's turning speed; this drop is eliminated when there are no magnetically conductive materials in close proximity to the magnet cylinder.

1) ADC Electric Motor consisting of a rotor on which is mounted a permanent unipolar radial magnet encircled by two or more radially symmetrically arranged stator electromagnets in series circuit, mounted with nonmagnetic materials and wound to send electric current in the same direction down lengths of wire parallel to the rotor's axis of rotation, which produces smooth, consistent torque without back-voltage proportional to the motor's turning speed.

2) A Universal Electric Motor consisting of a rotor on which is mounted a unipolar radial electromagnet encircled by and in series or parallel circuit with two or more radially symmetrically arranged stator electromagnets in series circuit, mounted with nonmagnetic materials and wound to send electric current in the same direction down lengths of wire parallel to the rotor's axis of rotation, which produces smooth, consistent torque without back-voltage proportional to the motor's turning speed.
